(19) United States
(12) Patent Application Publication
(10) Pub. No.: US 2012/0067967 A1
(43) Pub. Date: Mar. 22, 2012

(54) FLUID APPLICATOR AND METHOD

(75) Inventors: Sven van Delden, Lachendorf (DE); Dirk Froehlich, Celle (DE); Witali Huber, Laatzen (DE)

(73) Assignee: Baker Hughes Incorporated, Houston, TX (US)

(21) Appl. No.: 13/234,685

(22) Filed: Sep. 16, 2011

Related U.S. Application Data
(60) Provisional application No. 61/384,960, filed on Sep. 21, 2010.

(51) Int. Cl. B05B 17/04

(52) U.S. Cl. 239/7; 239/224

(57) ABSTRACT

A fluid applicator includes, a tubular configured to transport a fluid therethrough, and a rotatable member in operable communication with the tubular such that fluid transported through the tubular is deposited at the rotatable member near a rotational center of the rotatable member. The rotatable member is configured to produce sufficient centrifugal forces on the fluid through rotation thereof to urge the fluid radially outwardly from the rotatable member to coat an inside of an earth formation borehole tool.

### CROSS REFERENCE TO RELATED APPLICATIONS

This application claims priority to U.S. provisional application, 61/384,960, filed Sep. 21, 2010, the entire contents of which are incorporated herein by reference.

### BACKGROUND

Applying a coating of fluidized material, such as an adhesive or an electrical or thermal insulator, to a surface located within a radially constrained environment can be difficult. A desire for uniformity of the coating thickness can add further challenges. Devices and methods that permit application of coatings without the foregoing drawbacks would be well received by those practicing in the art.

### BRIEF DESCRIPTION

Disclosed herein is a fluid applicator. The fluid applicator includes, a tubular configured to transport a fluid therethrough, and a rotatable member in operable communication with the tubular such that fluid transported through the tubular is deposited at the rotatable member near a rotational center of the rotatable member. The rotatable member is configured to produce sufficient centrifugal forces on the fluid through rotation thereof to urge the fluid radially outwardly from the rotatable member to coat an inside of an earth formation borehole tool.

Further disclosed herein is a method of coating a borehole tool. The method includes, rotating a rotatable member, dispensing fluid near a rotational center of the rotatable member, discharging fluid from the rotatable member with centrifugal force generated by the rotating of the rotatable member, positioning the rotatable member within a borehole tool, and coating an inner surface of the borehole tool.

### BRIEF DESCRIPTION OF THE DRAWINGS

The following descriptions should not be considered limiting in any way. With reference to the accompanying drawings, like elements are numbered alike:

FIG. 1 depicts a side schematic view of a fluid applicator disclosed herein;

FIG. 2 depicts an end schematic view of the fluid applicator of FIG. 1; and

FIG. 3 depicts a side schematic view of a fluid applicator within a tubular target being coated.

### DETAILED DESCRIPTION

A detailed description of one or more embodiments of the disclosed apparatus and method are presented herein by way of exemplification and not limitation with reference to the Figures.

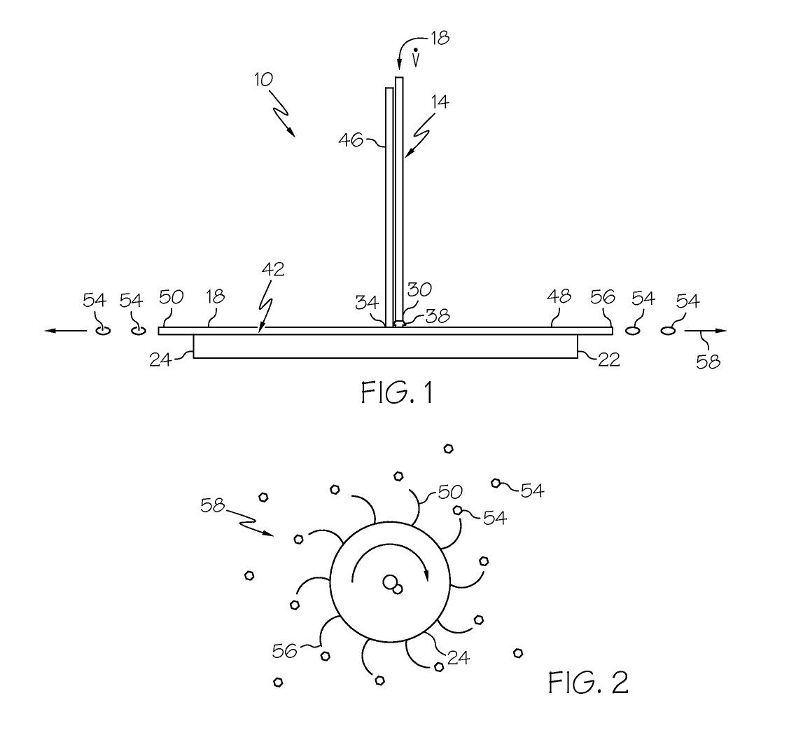

Referring to FIGS. 1 and 2, an embodiment of a fluid applicator is illustrated at 10. The applicator 10 includes, a tubular 14, for transporting a fluid 18, such as an adhesive or an insulator, for example, therethrough, and a rotatable member 22, illustrated in this embodiment as a disk having an edge 24. An end 30 of the tubular 14 is positioned near a rotational center 34 of the rotatable member 22, with an opening 38 of the tubular 14 being directed toward a surface 42 of the rotatable member 22. A shaft 46 is attached to the rotatable member 22 to rotationally support the rotatable member 22 while providing rotational motion thereto.

Rotation of the rotatable member 22 while the fluid 18 is on the surface 42 generates centrifugal forces on the fluid 18 thereby urging the fluid 18 in a radially outward direction from the rotatable member 22. The fluid 18 spreads to a thin film 48 on the surface 42 partially due to wetting of the fluid 18 to the surface 42 and surface tension of the fluid 18. As the fluid 18 is urged from the edge 24 the fluid 18 forms filaments 50 and then droplets 54 that are released from ends 56 of the filaments 50 in an atomizing process. This rotational atomizing process happens continuously and consistently and creates a monodisperse spray 58, where the many droplets 54 have substantially the same size and shape. It should be noted that although embodiments disclosed herein illustrate the rotatable member 22 as a disk, other shaped embodiments of rotatable members are contemplated to facilitate monodispersing coating fluids having various material properties.

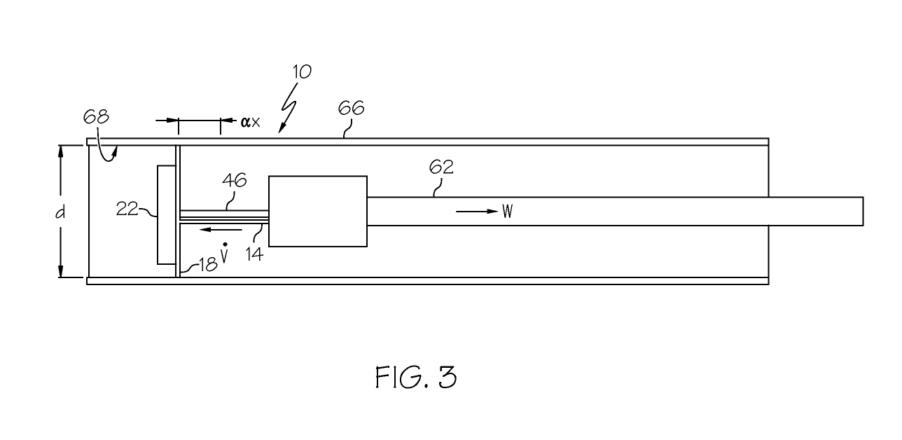

Referring to FIG. 3, the fluid applicator 10 optionally includes a lance 62 to which the tubular 14 and the shaft 46 are structurally and operationally attached. The lance 62 is configured to extend within a target 66 illustrated in this embodiment as a stator tube of a mud motor employable within a downhole borehole, for example, in a hydrocarbon recovery application.

Movement of the lance 62 can be controlled relative to the target 66 to facilitate forming a uniform coating on an inner surface 68 of the target 66 having a selected dry coat thickness δ, as defined by Formula 1, below:

$$δ = \frac{{M}_{tr}}{100} * \frac{{ζ}_{fluid}}{{ζ}_{dry}} * D \qquad 1$$

Since the theoretical thickness of the liquid layer of the coating is D, defined by Formula 2, below:

$$D = \frac{\partial V}{\partial A} ⇒ D = \frac{\dot{V} \partial t}{π d \partial x} = \frac{\dot{V}}{w π d} \qquad 2$$

then by substitution,

$$δ = \frac{{M}_{tr}}{100} * \frac{{ζ}_{fluid}}{{ζ}_{dry}} * \frac{\dot{V}}{w π d}$$

where,

$$\dot{V} = \frac{\partial V}{\partial t} and w = \frac{\partial x}{\partial t}$$

D=theoretical thickness of liquid layer of the fluid 18,

δ=thickness of dry layer of the fluid 18,

A=coated surface area of the target 66,

Mₜᵣ=solid content (%),

ζ_{fluid}=density of liquid of the fluid 18,

ζ_{dry}=density of dry fluid 18,

\dot{V}=volume flow,

w=lance velocity,

d=inner diameter of target 66 being coated, and

V=volume of fluid 18 dispensed.

As can be seen from the Formulae 1 and 2, the thickness of the dry layer of coating fluid can be accurately calculated by knowing and controlling the volume flow of the coating fluid and the lance velocity since all of the following are known: the area of the target being covered, the density of the coating fluid while liquid and while dry, and the percent of solid content of the coating fluid while a liquid.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A fluid applicator, comprising:
a tubular configured to transport a fluid therethrough; and
a rotatable member in operable communication with the tubular such that fluid transported through the tubular is deposited at the rotatable member near a rotational center of the rotatable member, the rotatable member being configured to produce sufficient centrifugal forces on the fluid through rotation thereof to urge the fluid radially outwardly from the rotatable member to coat an inside of an earth formation borehole tool.

2. The fluid applicator of claim 1, further comprising a lance that movably supports the rotatable member and the tubular.

3. The fluid applicator of claim 2, wherein the tubular, rotatable member and an end of the lance are configured to be moved within the earth formation borehole tool to be coated.

4. The fluid applicator of claim 1, wherein the earth formation borehole tool is a stator of a mud motor.

5. The fluid applicator of claim 1, wherein the rotatable member is configured to atomize the fluid.

6. The fluid applicator of claim 1, wherein the rotatable member includes an edge near an outer radial portion thereof.

7. The fluid applicator of claim 1, wherein the rotatable member is cup shaped.

8. The fluid applicator of claim 1, wherein the rotatable member is configured to be wetted by the fluid.

9. The fluid applicator of claim 1, wherein the fluid is an adhesive.

10. A method of coating a borehole tool, comprising:
rotating a rotatable member;
dispensing fluid near a rotational center of the rotatable member;
discharging fluid from the rotatable member with centrifugal force generated by the rotating of the rotatable member;
positioning the rotatable member within a borehole tool; and
coating an inner surface of the borehole tool.

11. The method of coating a borehole tool of claim 10 further comprising atomizing fluid.

12. The method of coating a borehole tool of claim 10 further comprising controlling a thickness of fluid dispensed onto the borehole tool at least in part by controlling a rate of the dispensing fluid.

13. The method of coating a borehole tool of claim 10 further comprising moving the rotatable member relative to the borehole tool being coated.

14. The method of coating a borehole tool of claim 10 further comprising controlling a thickness of fluid dispensed onto the borehole tool at least in part by controlling velocity of movement of the rotatable member relative to the borehole tool being coated.

15. The method of coating a borehole tool of claim 10 further comprising forming filaments with fluid.

16. The method of coating a borehole tool of claim 10 further comprising forming a film of fluid on the rotatable member.

17. The method of coating a borehole tool of claim 10 further comprising forming a monodisperse spray.

18. The method of coating a borehole tool of claim 10 further comprising calculating a dry thickness of fluid dispensed onto the borehole tool based at least in part on, a volume flow rate of fluid being dispensed, a percent of solid in fluid being dispensed, an area being coated, a density of fluid when liquid, a density of fluid when dry, and relative velocity between the borehole tool and the rotatable member.
